(19) United States
(12) Patent Application Publication
(10) Pub. No.: US 2016/0217393 A1
(43) Pub. Date: Jul. 28, 2016

(54) INFORMATION EXTRACTION

(71) Applicant: HEWLETT-PACKARD DEVELOPMENT COMPANY, L.P., Houston, TX (US)

(72) Inventors: Xiaofeng Yu, Beijing (CN); Shimin Chen, Beijing (CN)

(73) Assignee: Hewlett-Packard Development Company, L.P., Houston, TX (US)

(21) Appl. No.: 14/916,302

(22) PCT Filed: Sep. 12, 2013
(86) PCT No.: PCT/CN2013/083415

§ 371 Date: Mar. 3, 2016

(51) Int. Cl. G06N 99/00; G06N 7/00

(52) U.S. Cl. CPC G06N 99/005; G06N 7/005

(57) ABSTRACT

Information extraction from observed data may be performed. First parameter weights and second parameter weights of a joint discriminative probability distribution may be determined. The joint discriminative probability distribution may be over first variables and second variables and may be conditioned on the observed data. The second variables may be modeled by first-order logic formulas. The first variables may be based on the first parameter weights, and the second variables may be based on the second parameter weights. A first likely output of the first variables based on the first parameter weights and a second likely output of the second variables based on the second parameter weights may be determined.

### BACKGROUND

Information extraction (IE) problems are becoming increasingly important due to an increasing amount of data to process, such as in sources like the World Wide Web. Information extraction is the process of automatically extracting structured information from semi-structured or unstructured data. An example of unstructured data is natural language text found in a computer-readable document.

### BRIEF DESCRIPTION OF THE DRAWINGS

Some examples are described with respect to the following figures:

FIG. 1 is a flow diagram illustrating a method of information extraction from observed data according to some examples;

FIG. 2 is a simplified illustration of an information extraction system according to some examples;

FIG. 3 is a flow diagram illustrating a method of information extraction from observed data according to some examples; and

FIG. 4 is a graphical representation of a joint discriminative probability distribution according to an example.

### DETAILED DESCRIPTION

Before particular examples of the present disclosure are disclosed and described, it is to be understood that this disclosure is not limited to the particular examples disclosed herein as such may vary to some degree. It is also to be understood that the terminology used herein is used for the purpose of describing particular examples only and is not intended to be limiting, as the scope of the present disclosure will be defined only by the appended claims and equivalents thereof.

Notwithstanding the foregoing, the following terminology is understood to mean the following when recited by the specification or the claims. The singular forms ‘a,’‘an,’ and ‘the’ are intended to mean ‘one or more.’ For example, ‘a part’ includes reference to one or more of such a ‘part.’ Further, the terms ‘including’ and ‘having’ are intended to have the same meaning as the term ‘comprising’ has in patent law. The term ‘approximately’ when used in reference to a calculation or determination means that the calculation or determination provides an inexact solution, in contrast to a closed analytic solution, for example.

Many high-level information extraction problems include multiple “subtasks”, which are tasks to complete during information extraction. The subtasks may be interdependent on each other. For example, two such subtasks are (1) segmentation, which may involve identifying segments in observed data, and (2) relation discovery, which may involve discovering certain relations between the segments. Each segment may be labeled with a segment type, such as person, location, organization, date, year, time, number, miscellaneous, or the like. Each relation may be labeled with a relation type, such as employee, father, executive, job title, education, or the like. An example problem is to find segments and relations in observed data such as the natural language text “Barack Obama is a member of the Democratic Party and graduated from Harvard University.”

Accordingly, the present disclosure concerns information extraction systems, computer readable storage media, and methods of information extraction from observed data. In solving the example problem, the methods and systems herein may identify segments such as a segment “Barack Obama” whose segment type is “person”, segment “Democratic Party” whose segment type is “organization”, and segment “Harvard University” whose segment type is “school.” Additionally, the methods and systems herein may identify relations such as a relation “executive” between “Barack Obama” and “Democratic Party”, and a relation “education” between “Barack Obama” and “Harvard University.”

The methods and systems herein may effectively optimize and solve the subtasks jointly and simultaneously by using a joint discriminative probability distribution that incorporates first-order logic formulas. As defined herein, a “joint discriminative probabilistic model” or “joint discriminative probability distribution” is a model to predict two unobserved variables a and b from an observed variable c according to a joint conditional probability distribution such as P(α, b|c)=P(α|c)P(b |α, c). Thus, the model may predict the variables a and b jointly such that they can be optimized simultaneously.

The joint discriminative probability distribution may be used in a top-down and bottom-up bidirectional manner to exploit dependencies and interactions between the subtasks, and may provide flexibility to incorporate both uncertainty of probabilistic graph models which may be effective for segmentation, and first-order logic for domain knowledge concisely formulated by first-order logic formulas which may be effective for relation discovery. Thus, employing first-order logic in a joint discriminative probabilistic model may result in high performance for both segmentation and relation discovery, and may reduce cascading error accumulation. “First order-logic formulas” are symbolized formulas that formalize statements that include a subject and a predicate, and in which the predicate modifies or defines the properties of the subject. In first-order logic, a predicate refers to a single subject, not multiple subjects.

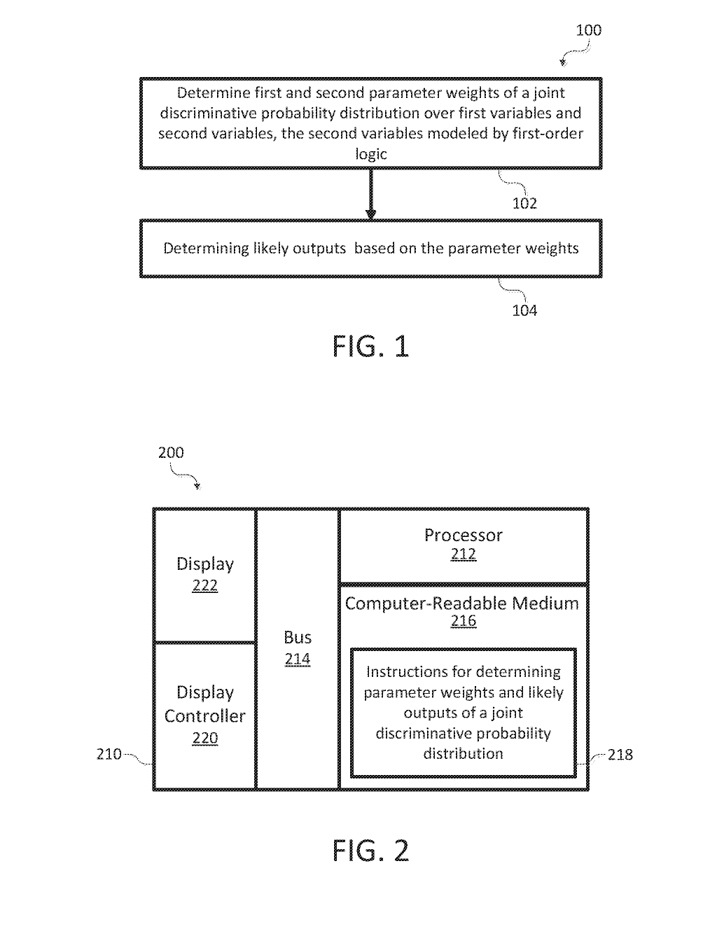

FIG. 1 is a flow diagram illustrating a method 100 of information extraction from observed data according to some examples. The method 100 may be performed by a processor. At block 102, first parameter weights and second parameter weights of a joint discriminative probability distribution may be determined. The joint discriminative probability distribution may be over first variables and second variables and may be conditioned on the observed data. The second variables may be modeled by first-order logic formulas. The first variables may be based on the first parameter weights, and the second variables may be based on the second parameter weights. At block 104, a first likely output of the first variables based on the first parameter weights and a second likely output of the second variables based on the second parameter weights may be determined.

FIG. 2 is a simplified illustration of an information extraction system 200 according to some examples. The system 200 may include a computer system 210. Any of the operations and methods disclosed herein may be implemented and controlled in the system 200 and/or the computer system 210. The computer system 210 may include a processor 212 for executing instructions such as those described in the methods herein. The processor 212 may, for example, be a microprocessor, a microcontroller, a programmable gate array, an application specific integrated circuit, a computer processor, or the like. The processor 212 may, for example, include multiple cores on a chip, multiple cores across multiple chips, multiple cores across multiple devices, or combinations thereof. In some examples, the processor 212 may include at least one integrated circuit (IC), other control logic, other electronic circuits, or combinations thereof.

The computer system 210 may include a display controller 220 responsive to instructions to generate a textual or graphical display of any of the observed data, likely outputs, intermediate data, or graphical representations of the methods disclosed herein, on a display device 222 such as a computer monitor, camera display, smartphone display, or the like.

The processor 212 may be in communication with a computer-readable medium 216 via a communication bus 214. The computer-readable medium 216 may include a single medium or multiple media. For example, the computer readable medium may include one or both of a memory of the ASIC, and a separate memory in the computer system 210. The computer readable medium 216 may be any electronic, magnetic, optical, or other physical storage device. For example, the computer-readable storage medium 216 may be, for example, random access memory (RAM), static memory, read only memory, an electrically erasable programmable read-only memory (EEPROM), a hard drive, an optical drive, a storage drive, a CD, a DVD, and the like. The computer-readable medium 216 may be non-transitory. The computer-readable medium 216 may store, encode, or carry computer executable instructions 218 that, when executed by the processor 212, may cause the processor 212 to perform any one or more of the methods or operations disclosed herein according to various examples.

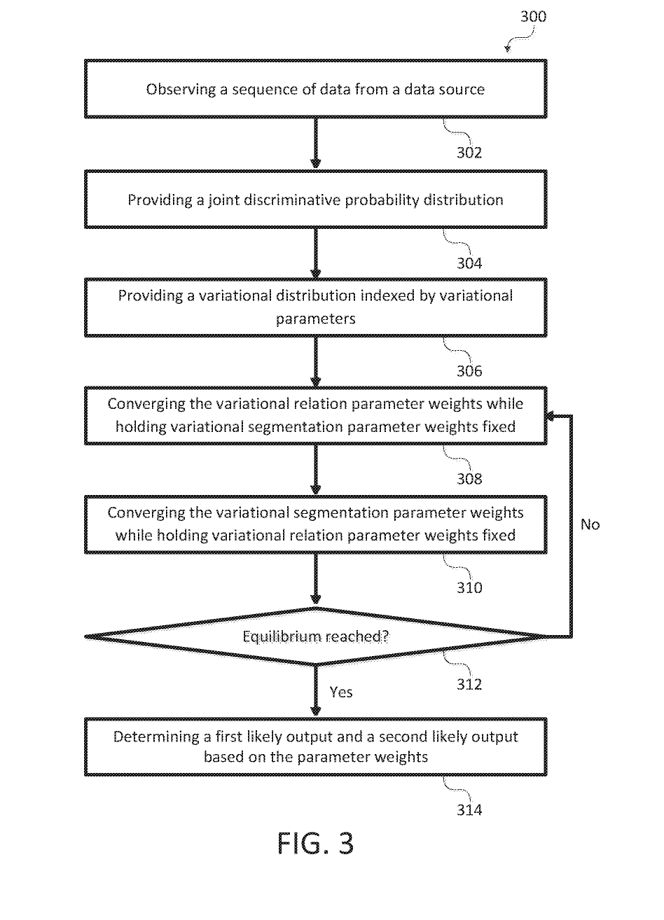

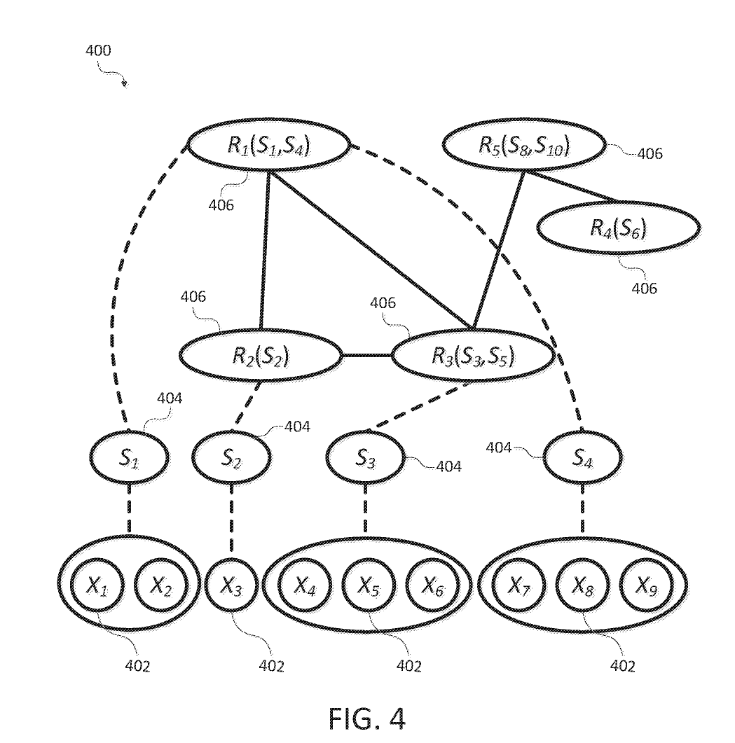

FIG. 3 is a flow diagram illustrating a method 300 of information extraction from observed data according to some examples. In describing FIG. 3, reference will be made to FIG. 4, which is a graphical representation of the joint discriminative probability distribution 400 over segments S and relations R conditioned on observed data X, according to an example. In some examples, the ordering shown may be varied, such that some steps may occur simultaneously, some steps may be added, and some steps may be omitted.

At block 302, a sequence of data X={X₁,X₂, . . . Xₙ}, designated by reference numeral 402 in FIG. 4, may be observed from a data source such as a computer-readable document or web page. The data X may be unstructured or semi-structured, for example. The data X may be text, and each token, such as X₁, may be a word, for example.

The information extraction method 300 may be able to solve a number of information extraction problems based on the data X. An example problem is to perform two subtasks, segmentation and relation discovery. Y={R,S} is the set of possible segments S of the data X and possible relations R between possible segments S. The problem may be to find the set Y*={R*,S*} of most likely segments S* of the data X and most likely relations R* between potential segments S, where S* is contained in S (S* εS) and R* is contained in R (R*εR). Thus, Y* may have the maximum a posteriori (MAP) probability of the possible assignments Y given the data X, namely Y*=arg max_{Y}P(Y|X).

As defined herein, “segmentation” is the task assigning one or more most likely segments S* to the data X. For example, a segment S₁^{*}may be assigned to token X₁, and a segment S₂^{*}may be assigned to tokens X₂ and X₃. Thus, a “segment” is a unit assigned to one or more tokens. In some examples, only adjacent tokens may form a segment. In such examples, a segment cannot be assigned to tokens X₁ and X₃. Segmentation may be used for word segmentation, chunking, and/or entity recognition, for example. Additionally, as defined herein, “relation discovery” is the task of discovering one or more most likely relations R* between pairs of potential segments S. Relation discovery may be used for entity resolution, relation extraction, and/or social relation mining, for example.

At block 304, an information extraction model may be loaded and provided. The model may be a joint discriminative probability distribution P(Y|X) over multiple variables Y, such as segmentation variables representing possible segments S and relation variables representing possible relations R, conditioned on the observed data X. Thus, the joint discriminative probability distribution P(Y|X) may model a first subtask and a second subtask. The joint discriminative probability distribution P(Y|X) may be represented as a factor graph, The joint discriminative probability distribution may take many forms. An example form is as an exponential family, such as Markov random fields or Markov networks. A “Markov random field” or “Markov network” is understood herein a set of random variables that (1) have a “Markov property”, in that they are variables in “Markov chain”, which is a stochastic process that is memoryless, and (2) are represented as an “undirected graph”, which is a graph having edges with no orientation, i.e. no directionality. In some examples, the joint discriminative probability distribution may be defined as:

$$P ( Y \vert X ) = \frac{1}{Z ( X )} {\prod }_{{ϕ}_{i} ∈ G} exp \{ {\sum }_{k} {μ}_{ik} {f}_{ik} ( {X}_{i} , {Y}_{i} ) \}$$

Z(X) is a normalization function. The exponential of the joint discriminative probability distribution may be factored into a product of factored exponential families φᵢ=exp{Σₖμᵢₖƒᵢₖ (Xᵢ, Yᵢ)}, as shown. Each factored exponential family φᵢ may be a real, scalar value over sufficient statistics ƒᵢₖ(Xᵢ, Yᵢ), each weighted by a parameter μᵢₖ, of the subset of variables Yᵢ and Xᵢ that are neighbors of φᵢin the factor graph G. The neighbors may form “cliques”, which are defined herein to be complete subgraphs in which every pair of distinct vertices of the subgraph is connected by a unique edge. This model can represent a large number of random variables as a family of probability distributions that factorize according to an underlying graph, and it can capture complex dependencies between variables.

The factors of the joint discriminative probability distribution P(Y|X) may be partitioned into two or more factors each representing a particular subtask. For example, the joint discriminative probability distribution P(Y|X) may be factored into a product of: (1) a probability distribution P(S|X) over possible segmentations S, designated by reference numeral 404 in FIG. 4, conditioned on observed data X, and (2) a probability distribution P(R|S,X) over possible relations R, designated by reference numeral 406 in FIG. 4, conditioned on possible segmentations S and observed data X. This may be done by partitioning, according to the Hammersley-Clifford theorem, the factors of the joint discriminative probability distribution P(Y|X) into a first subtask factor such as a segmentation factor Π_{cεC}_{ₛ}exp{Σᵢ₌₁^{W}^{ₛ}λ_{ic}gᵢ}, and a second subtask factor such as relation factor Π_{dεC}_{_{R}}exp{Σⱼ₌₁^{W}^{_{R}}θ_{jd}ƒⱼ}, each of which may be a clique:

$$P ( Y \vert X ) = P ( S \vert X ) P ( R \vert S , X ) = \frac{1}{Z ( X )} {\prod }_{c ∈ S} exp \{ {\sum }_{i = 1}^{{W}_{S}} {λ}_{ic} {g}_{i} \} {\prod }_{d ∈ S} exp \{ {\sum }_{i = 1}^{{W}_{R}} {θ}_{jd} {f}_{j} \}$$

The “Hammersley-Clifford theorem” states that a probability distribution with a positive density can be factorized over its cliques, if and only if it satisfies a Markov property with respect to an undirected graph. Thus, because as discussed earlier P(Y|X) may satisfy a Markov property, the segmentation and relation factors may be factored over their cliques.

The feature functions gᵢ may be weighted by a first subset λ_{ic} of the parameter weights λ_{ic} and θ_{jd,} and the first-order logic formulas ƒⱼ may be weighted by a second subset θ_{jd} of the parameter weights λ_{ic} and θ_{jd.} “Parameter weights” are weights given to functions in the joint discriminative probability distribution.

Each exponential family exp{93 ᵢ₌₁^{w}_{ic}gᵢ}corresponds to one candidate segment S_{c} of all possible segments S of the data X, where Wₛ is the number of feature functions gᵢ, which may model the first subtask and the first variables, e.g. segmentation variables representing segments S. Each “feature function” gᵢ defines a particular rule that results in segmentation of the data X into the candidate segment S_{c}. Additionally, to effectively capture properties of segmentation, the feature functions gᵢ may be semi-Markovian to form “semi-Markov chains”, in that each feature function gᵢ may depend on the current segment S_{c}, the previous segment S_{c-1}, and the data X, such that gᵢ=gᵢ(S_{c},S_{c-1}, S_{c-1}, X). The likelihood that the data X are correctly segmented into candidate segment S_{c}based on a particular feature function gᵢ is represented by a real-valued parameter weight λ_{ic}. Thus, the total likelihood of segmenting into candidate segment S_{c} is provided by the set of all parameter weights of a given S_{c}, namely λ_{c}={λ_{i=1,c}, λ_{i=2,c}, . . . λ_{i=W}_{ₛ}_{,c}}.

The following demonstrates how this model may be applied to the example problem mentioned earlier to find segments in the natural language text “Barack Obama is a member of the Democratic Party and graduated from Harvard University,” In this example, each labeled token may be represented with the letter I along with a segment type, and each non-labeled token may be represented with an O. Thus, the 15 tokens, including 14 words and 1 period, may be sequentially labeled as {I-PERSON,/PERSON,O,O,O,O,O-ORGANIZATION,I-ORGANIZATION,O,O,O,-I-SCHOOL,I-SCHOOL,O}. The correct corresponding sequence of segments may be {<1,2,1-PER>,<3,3,O>,<4,4,O>,<5,5,O>,<6,6,>,<7,7,O>,<8,9,I-ORG>,<10,10,>,<11,11,O>,<12,12,O>,<13,14,I-SCHOOL>,<15,15,O>}, where each segment is represented as <starting position, end position, label>. Two possible feature functions gᵢ for the segment <8,9,I-ORG>may be g(I-ORG,O,X,8,9) and g(I-ORG, I-ORG,X,8,9). In the former, the current 8th token is labeled with I-ORG and the previous 7th token is labeled with O, and in the latter, both the current 9th token and previous 8th tokens are labeled with I-ORG.

Each exponential family exp{Σⱼ₌₁^{W}^{_{R}}θ_{jd}ƒⱼ}corresponds to one candidate relation R_{d} of all possible relations R between possible segments S, where W_{R} is the number of first order logic formulas ƒⱼ, which may model the second subtask and the second variables, e.g. relation variables representing relations R. For example, if the set of all possible segments S includes four possible segments, then the set of all possible relations R may include four possible relations applicable to only a single segment, and six possible relations between segment pairs. In some examples, the set of relations R may include relations R_{d} that relate more than two segments S_{C}. Each first-order logic formula ƒⱼ may result in the candidate relation R_{d} between possible segments S. Initially, in the form of a Markov network, the relations R_{d}, which each may be modeled by the first-order logic formulas ƒⱼ, may not have truth values until they are interpreted in some way. One such way to assign truth values is to interpret the relations R_{d} with a “Herbrand interpretation”, meaning that the constants in each exponential family exp{Σⱼ₌₁^{W}^{_{R}}θ_{jd}ƒⱼ} are interpreted as themselves, and each function symbol in each exponential family exp{Σⱼ₌₁^{W}^{_{R}}θ_{jd}ƒⱼ} is interpreted as a function applying the function symbol. This results in the Markov network becoming what is known as a “ground Markov network”, in which some relations R_{d} are “false” and some “true”. In some examples, each first order logic formula ƒⱼ may have a value of either a low value, if the relation according to that formula is likely to be false, or a high value, if the relation according to that formula is likely to be true. An example first-order logic formula represents that “if a person is a father, then the person is male”, i.e. father(x)→male(x). Further examples include “playing sports regularly makes one healthy”, i.e. sports(x)→healthy(x), and “friends have similar sports habits”, i.e. friends(x,y)→(sports(x)sports(y)). The likelihood that particular segments in S are correctly related by relation R_{d} based on a particular first-order logic formula ƒⱼ is represented by a real-valued parameter weight θ_{jd}. Thus, the total likelihood of selecting a relation R_{d} is provided by the set of all parameter weights of a given R_{d}, namely θ_{d}={θ_{j=1,d}, θ_{j=2,d}, . . . , θ_{j=W}_{ₛ}_{,d}}. Because relation discovery may be cast in the form of first-order logic formulas, the model may be able to capture a rich class of relations and dependencies, such as long-distance dependencies.

The following demonstrates how this model may be applied to the example problem mentioned earlier to find relations in the natural language text “Barack Obama is a member of the Democratic Party and graduated from Harvard University.” In this example, correct relations may be the relation “executive” between segment “Barack Obama” i.e. <1,2,I-PER> and segment “Democratic Party” i.e. <8,9,I-ORG>, and the relation “education” between segment “Barack Obama” and segment “Harvard University” i.e. <13,14,I-SCHOOL>. One possible first-order logic formulas ƒⱼ may represent the claim that “people attend school”. Thus, this formula may be equal to (1) a high probability value if the segment comprising tokens 8 and 9 is labeled as a person and the segment comprising tokens 13 and 14 is labeled as a school, in which case the relation may be labeled as “education”, or (2) a low probability value if the segment comprising tokens 8 and 9 is not labeled as a person or the segment comprising tokens 13 and 14 is not labeled as a school. If the first-order logic formula ƒⱼ correctly represents a relation between these segments, its parameter weight θ_{jd} may be likely to be high. Otherwise, its parameter weight θ_{jd} may be likely to be low.

In FIG. 4, four candidate segments S₁, S₂, S₃, and S₄ are shown for segmenting nine tokens X₁, X₂, . . . , X₉ via mappings 408. Some segments, such as S₁, may be assigned to multiple tokens, whereas other segments, such as S₂, may be assigned to a single token. Although not shown, other candidate segments may be possible as well for the nine tokens. Additionally, in FIG. 4 five candidate relations R₁, R₂, R₃, R₄, and R₅ are shown for relating segments. For example, R₁ relates S₁ and S₄, and R₂ relates only to S₂, indicating that S₂ may not relate to any other segments. Each of the nodes in the graph having relations R_{d} may be ground atoms with a possible world or Herbrand interpretation for assigning a truth value to the node. Additionally, the relations themselves may have dependencies between each other, as shown in FIG. 4.

At blocks 306 to 312, the parameters weights λ_{ic}, of each of the first variables and the parameter weights θ_{jd} of each of the second variables may be determined. For example, the parameter weights may be estimated approximately by a “variational expectation maximization (VEM) algorithm”, which is an iterative method for finding maximum likelihood or maximum a posteriori (MAP) estimates of variational parameter weights, using V, E, and M steps such as those discussed at blocks 306 to 312. The VEM algorithm may, in some examples, operate in a top-down and bottom-up manner to optimize subtasks, e.g. segmentation and relation discovery, iteratively and collaboratively using hypotheses from each other, such that information may flow bi-directionally between the subtasks to obtain mutual benefits for each of the subtasks. The VEM algorithm may, for example, provide a fast, deterministic approximation, whose convergence time may be independent of dimensionality of the exponential family of P(Y|X). In some examples, the VEM algorithm may operate as follows.

At block 306, in the V step, a variational distribution Q indexed by a set of variational parameters weights, such as variational segmentation parameter weights and variational relation parameter weights, may be generated and provided. “Variational parameters weights” are parameter weights that are varied toward particular values. The variational distribution Q may be an approximation of the target distribution P(Y|X). The variational distribution Q may be selected from a family of variational distributions, such that it may be most feasible and most mathematically tractable to perform inference at block 314 on the selected variational distribution Q relative to other possible variational distributions.

The variational distribution Q may be a naive (i.e. non-structured) variational distribution. A structured variation distribution involves performing exact probability calculations on tractable substructures, combined with variational methods to capture the interactions between substructures, However, in cases where the probability distribution to be calculated is fully factorized, such that the interacting variables are independent and the joint distribution is a product of single variable marginal probabilities, a nave non-structured variational distribution may be used.

At blocks 308 to 312, an expectation maximization (EM) based optimization algorithm may be applied to iteratively update the variational parameter weights such that the values of the variational parameter weights may converge toward the values of the parameter weights λ_{ic} and θ_{jd}.

At block 308, in the E-step, the variational segmentation parameter weights of the variational distribution Q may be held fixed while bottom-up learning may be performed, using the hypotheses from segmentations, to converge the variational relation parameter weights of the variational distribution Q toward the values of the relation parameter weights θ_{jd}.

At block 310, in the M-step, the variational relation parameter weights may be held fixed while top-down learning may be performed, using the hypotheses from relation discovery, to converge the variational segmentation parameter weights toward the values of the segmentation parameter weights λ_{ic}.

The variational parameters may converge to an equilibrium, such that the Kullback-Leibler (KL) divergence between the variational distribution Q and the target distribution P(Y|X) may reach a stable minimum, which may be an optimal solution according to nave mean-field variational theory. Such iterative optimization allows information to flow bi-directionally to boost both the segmentation and relation discovery performance. Thus, at equilibrium, the values of the parameter weights λ_{ic} and θ_{jd} may be estimated to be equal to the values of the equilibrium variational parameter weights.

At decision block 312, whether equilibrium values of the variational parameter weights have been reached may be determined. If equilibrium is reached, the method may proceed to block 314. If equilibrium is not reached, the method 300 may proceed back to block 308. In some examples, the decision may be made based on whether a threshold number of iterations of blocks 308 and 310 has been reached, rather than based on whether equilibrium is reached.

At block 314, a first likely output of the first variables and a second likely output of the second variables may be determined based on the parameter weights λ_{ic}, and θ_{jd}, where the first likely output associated with the first subtask and the second likely output associated with the second subtask. For example, inference may be performed to find Y′=arg max_{Y} P(Y|X), which may be the maximum a posteriori (MAP) probability of the possible assignments Y given the data X. Inference may be performed approximately, given the large data set of possible segments S and possible relations R. For example, inference may be performed by a bidirectional Markov chain Monte Carlo (MCMC) algorithm to find the maximum a posteriori (MAP) assignment Y*, which represents likely segments S* and likely relations R*, as discussed earlier. An “MCMC algorithm” is understood herein to sample the probability distribution P(Y|X) by generating a Markov chain having the probability distribution P(Y|X) as its equilibrium distribution after a number of steps in the Markov chain. In some examples, the MCMC algorithm may be guaranteed to converge to the equilibrium distribution. In some examples, a Metropolis-Hastings (MH) algorithm, which is a type of MCMC algorithm, may be used. An “MH algorithm”, in addition to the general properties of MCMC algorithms, is understood herein to sample the probability distribution P(Y|X) indirectly, for example by generating a histogram or integral that approximates the probability distribution P(Y|X). The MCMC algorithms above may sample from both semi-Markov chains of the segmentation factor Π_{cεC}_{_{S}}exp{Σᵢ₌₁^{W}^{_{S}}λᵢgᵢ} and ground Markov networks of the relation factor Π_{dεC}_{_{R}}exp{Σⱼ₌₁^{W}^{_{R}}θⱼƒⱼ} jointly to achieve joint inference. This may provide strong coupling between subtasks by allowing information to flow in bi-directially to exploit relationships between the segmentations and relation discovery subtasks.

By modeling the segments S and relations R simultaneously, the methods herein may provide natural ways to perform joint information extraction, and may reduce error propagation. As the segments from the semi-Markov chains of the segmentation factor may be dynamically changed, the relation factor may correspondingly change based on the changed segmentations. Likewise, changed relation factor may influence segmentation. Thus, the model captures bidirectional top-down and bottom-up dependencies between multiple subtasks for joint information extraction problems.

In one example, experiments were performed on segmentation and relation discovery from 1,127 paragraphs from 441 pages of English encyclopedic articles in Wikipedia. For reference, initially information was extracted manually from the data. This yielded 7,740 entities labeled into 8 categories, including 1,243 person, 1,085 location, 875 organization, 641 date, 1,495 year, 38 time, 59 number, and 2,304 miscellaneous names. This data also contained 4,701 relation instances and 53 labeled relation types. To compare the manual performance to the performance of the tested example method, a standard measure was used of Precision (P), Recall (R), and F-measure, which is the harmonic mean of P and R, namely (2PR)/(P+R), for both segmentation and relation discovery. The token-wise labeling accuracy was also determined. The test example method achieved high performance. For segmentation, the test example method achieved an accuracy of 97.55, a precision of 94.03, a recall of 93.89, and an F-measure of 93.96. For relation discovery, the test example method achieved an accuracy of 96.92, a precision of 72.89, a recall of 64.20, and an F-measure of 68.27. It should be noted that these results are applicable to only one example of the methods herein.

Thus, there have been described examples of information extraction systems, computer readable storage media, and methods of information extraction. In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

What is claimed is:

1. A method of information extraction from observed data, the method comprising:
by a processor:
determining first parameter weights and second parameter weights of a joint discriminative probability distribution that is over first variables and second variables and conditioned on the observed data, the second variables modeled by first-order logic formulas, the first variables based on the first parameter weights, the second variables based on the second parameter weights;
determining a first likely output of the first variables based on the first parameter weights and a second likely output of the second variables based on the second parameter weights.

2. The method of claim 1 wherein the first variables comprise segmentation variables representing segments.

3. The method of claim 2 wherein the second variables comprise relation variables representing relations of the segments.

4. The method of claim 1 wherein the joint discriminative probability distribution is partitioned into a first subtask factor modeling the first variables and a second subtask factor modeling the second variables, the first subtask factor comprising feature functions weighted by the first parameter weights, the second subtask factor comprising the first-order logic formulas weighted by the second parameter weights.

5. The method of claim 1 wherein determining the first and second parameter weights comprises estimating the first and second parameter weights approximately using a variational expectation maximization (VEM) algorithm.

6. The method of claim 5 wherein estimating the first and second parameter weights comprises bi-directionally converging variational parameter weights until equilibrium values of the variational parameter weights are reached, wherein the variational parameter weights are weights of a non-structured variational distribution.

7. The method of claim 1 wherein determining the first likely output and the second likely output comprises performing inference approximately using a bidirectional Markov chain Monte Carlo (MCMC) algorithm.

8. A non-transitory computer readable storage medium including executable instructions that, when executed by a processor, cause the processor to:
determine first parameter weights and second parameter weights of a joint discriminative probability distribution that is over first variables and second variables and conditioned on observed data, the first variables modeled by feature functions weighted by the first parameter weights, the second variables modeled by first-order logic formulas weighted by the second parameter weights;
determine, based on the determined first and second parameter weights, likely outputs of the first and second variables.

9. The non-transitory computer readable storage medium of claim 8 wherein the first variables comprise segments and the second variables comprise relations of the segments.

10. The non-transitory computer readable storage medium of claim 8 wherein the joint discriminative probability distribution is partitioned into a first subtask factor modeling the first variables and a second subtask factor modeling the second variables.

11. The non-transitory computer readable storage medium of claim 8 wherein determining the first and second parameter weights comprises estimating the first and second parameter weights approximately using a variational expectation maximization (VEM) algorithm.

12. The non-transitory computer readable storage medium of claim 11 wherein estimating the first and second parameter weights comprises bi-directionally converging variational parameter weights until equilibrium values of the variational parameter weights are reached, wherein the variational parameter weights are weights of a non-structured variational distribution.

13. The non-transitory computer readable storage medium of claim 8 wherein determining the first likely output and the second likely output comprises performing inference approximately using a bidirectional Markov chain Monte Carlo (MCMC) algorithm.

14. A method of information extraction from observed data, the method comprising:
by a processor:
determining first parameter weights and second parameter weights of a joint discriminative probability distribution that models a first subtask and a second subtask and is conditioned on the observed data, the second subtask modeled by first-order logic formulas, the first parameter weights modeling the first subtask, the second parameter weights modeling the second subtasks; and
determining a first likely output associated with the first subtask based on the first parameter weights and a second likely output associated with the second subtask based on the second parameter weights.

15. The method of claim 14 wherein the joint discriminative probability distribution is partitioned into first subtask factor modeling the first subtask and a second subtask factor modeling the second subtask, the first subtask factor comprising feature functions weighted by the first parameter weights, the second subtask factor comprising the first-order logic formulas weighted by the second parameter weights.
